(19) United States
(12) Patent Application Publication
(10) Pub. No.: US 2009/0257855 A1
(43) Pub. Date: Oct. 15, 2009

(54) ELEVATABLE AND SELECTIVELY PIVOTABLE FRAME STRUCTURE FOR USE SUCH AS BY HAIR CARE PROFESSIONALS WITH INDIVIDUALS SEATED WITHIN A WHEELCHAIR

(76) Inventor: Kimberly J. Iannelli, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/101,369

(22) Filed: Apr. 11, 2008

(51) Int. Cl. B60P 1/46

(52) U.S. Cl. 414/540

(57) ABSTRACT

An assembly providing such as a hair care professional the ability to secure and elevate a physically challenged individual seated upon a wheelchair. A frame includes first and second spaced apart and crosswise-reinforced channels defining travel locations for receiving forward and rearward pairs of wheelchair wheels. A pair of crosswise extending locks associated with intermediate locations of the channels define spaced distances from end locations thereof to prevent relative movement of the wheelchair wheels when supported thereupon. First and second supports secure to the frame and extend upwardly relative to an open area between the channels. A pedestal includes a floor base from which vertically actuates a cylinder arranged to extend through the frame open area and between the supports, the supports mounting to the cylinder in order to secure the frame in balanced and vertically displaceable fashion upon the pedestal.

### FIELD OF THE INVENTION

The present invention relates generally to an elevatable structure for use such as by an individual seated upon a wheelchair. More specifically, the present invention teaches a novel frame structure incorporated into a hair salon pedestal supported lift, and which provides such as a hair care professional with the ability to secure, elevate and selectively pivot a physically challenged individual seated upon a wheelchair.

### DESCRIPTION OF THE PRIOR ART

The prior art is well documented with lift device configurations, and which are in particular useful in lifting a disabled person seated upon a conventional wheelchair. A first example of such a device is disclosed in U.S. Pat. No. 4,592,695, issued to McConnell, and which teaches a tilting platform lift device for wheelchairs. The device securely holds a wheelchair and tilts the same backwards up to 90 degrees to permit shampooing of the hair of the person seated thereupon. The device includes a tilting platform floor with attached frame, a motor-driven hydraulic system including a double-acting hydraulic cylinder, a four-way control valve, and electric motor, hydraulic pump, and hydraulic reservoir.

A system is enclosed within a case aid which acts as a base for the platform floor. In operation, a person in the wheelchair rolls backward up a ramp and is secured upon the platform floor by chains, these attaching to the arms of the wheelchair. The platform floor may be tilted forward and backward by operating the lever.

U.S. Pat. No. 6,478,529, issued to Willey et al., teaches a reclining support for a wheelchair and which includes a supporting platform wall that supports all four wheels of a wheelchair on a surface. A backstop wall operates for stopping the large rear wheels of the wheelchair so that the wheelchair is stably supported on the platform. Clamps are used for holding the frame on the platform, and so that the wheelchair does not move. The platform is mounted onto a base frame through a pivot mounting so it can be tilted rearwardly, and also the platform is adjustable in a vertical direction relative to the base frame. The base frame has four wheels for stably supporting the platform.

U.S. Pat. No. 5,040,939, issued to Booth, discloses a wheelchair lift for tilting a wheelchair and occupant backwards to a position for having his or her hair dressed or dental work or the like performed and which includes a pivotable frame onto which the wheelchair is rolled and secured. The lift also includes a fixed frame, a telescoping arm pivotally attached to the fixed frame and to the rear of the pivotable frame, and an electric motor drive which retracts and extends the telescoping arm to pivot the pivotable frame and wheelchair attached thereto about a pivot axis where the pivotable frame and the fixed frame are connected. The pivotable frame includes a horizontal section and an upright section that are connected at the pivot axis. The upright section includes a headrest that is adjustable. In one position the headrest supports the head of the occupant to allow work such as dental work to be performed while in a second position the headrest is retracted beneath the level of the wheelchair to allow free movement of the occupant's head to permit hair washing and the like.

Finally, U.S. Pat. No. 6,866,288, issued to Martin, teaches a convertible wheelchair and separate lift module for connecting to and elevating the wheelchair. A coupling assembly is operatively associated with the lift module and adapted to extend therefrom to where the coupling assembly attaches to the convertible wheelchair. In one embodiment, the coupling assembly includes a three-point attachment that results in the wheelchair being connected to the coupling assembly and hence the separable lift system at three points. Once coupled to the lift system, the convertible wheelchair, with a patient supported therein, can be raised to a selected elevation. Thereafter, the wheelchair can be converted from a chair configuration to any one of several examination configurations.

### SUMMARY OF THE INVENTION

The present invention discloses a novel frame structure incorporated into a hair salon pedestal supported lift and which provides such as a hair care professional with the ability to secure, elevate and selectively pivot a physically challenged individual seated upon a wheelchair. In particular, the present invention is an improvement over prior art lift assemblies in that provides a roll-on/roll-off frame suitable for use with a wheelchair and which is capable of easily installed, such as in retrofitting fashion, with a cylinder actuated hydraulic lift component associated with a salon chair.

A frame includes first and second spaced apart and crosswise-reinforced channels defining travel locations for receiving forward and rearward pairs of wheelchair wheels. A pair of crosswise extending locks associated with intermediate locations of the channels define spaced distances from end locations thereof, and to prevent relative movement of the wheelchair wheels when supported thereupon.

First and second supports secure to the frame and extend upwardly relative to an open area between the channels. The supports are typically in the form of forward and rearward spaced drop bars, each substantially “U” shaped in configuration.

A pedestal includes a floor base from which vertically actuates a cylinder arranged to extend through the frame open area sand between the supports. An upper end plate is typically mounted to a top end of the cylinder and to which the supports mount in order to secure the frame in balanced and vertically displaceable fashion upon the pedestal.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an operational view of a wheelchair being rolled onto the elevatable frame structure of the present invention, positioned in a lowermost ingress position;

FIG. 2 is a supported and locked position of the wheelchair relative to the frame structure illustrated in FIG. 1;

FIG. 3 is a succeeding and wheelchair lift view of the assembly shown in FIG. 2;

FIG. 4 is a ninety degree rotated end view of the wheelchair illustrated in phantom and which is supported upon the lift frame and associated and hydraulically actuated pedestal base according to the present invention;

FIG. 5 is all exploded view of the frame construction and associated vertically actuable pedestal support according to the present invention;

FIG. 6 is an enlarged sectional view of the mounting arrangement established between the frame construction and vertically actuating cylinder associated with the pedestal lift base;

FIG. 7 is an enlarged sectional view of the selected and rotatable crosspiece lock for preventing movement of the wheelchair when engaged upon the lift frame; and

FIG. 8 is a modified sectional view of the mounting arrangement shown in FIG. 6 and further illustrating, in phantom, a coupling arrangement according to an alternate variant for affording pivoting movement of the ramp/frame and associated elevatable wheelchair according to the present invention.

### DETAILED DESCRIPTION OF THE PREFERRED EMBODIMENTS

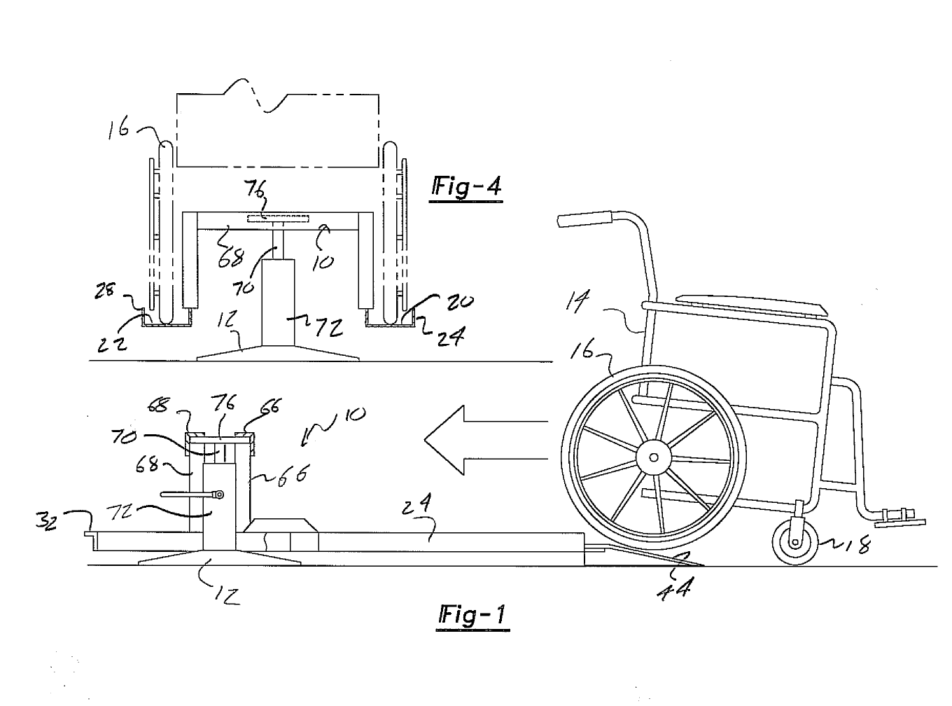

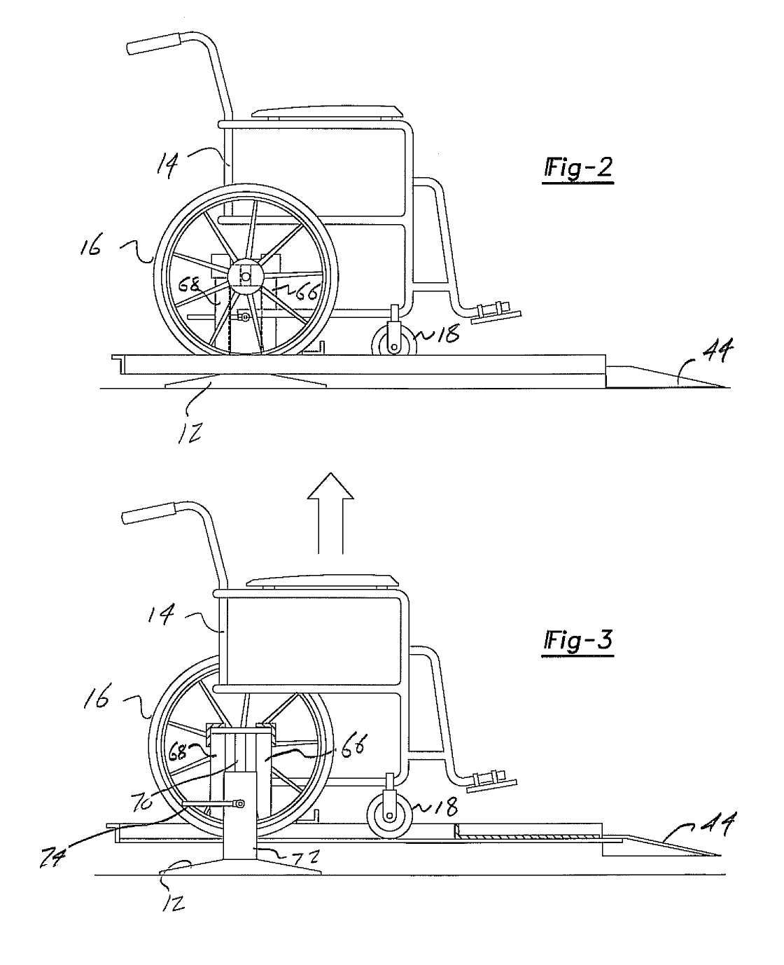

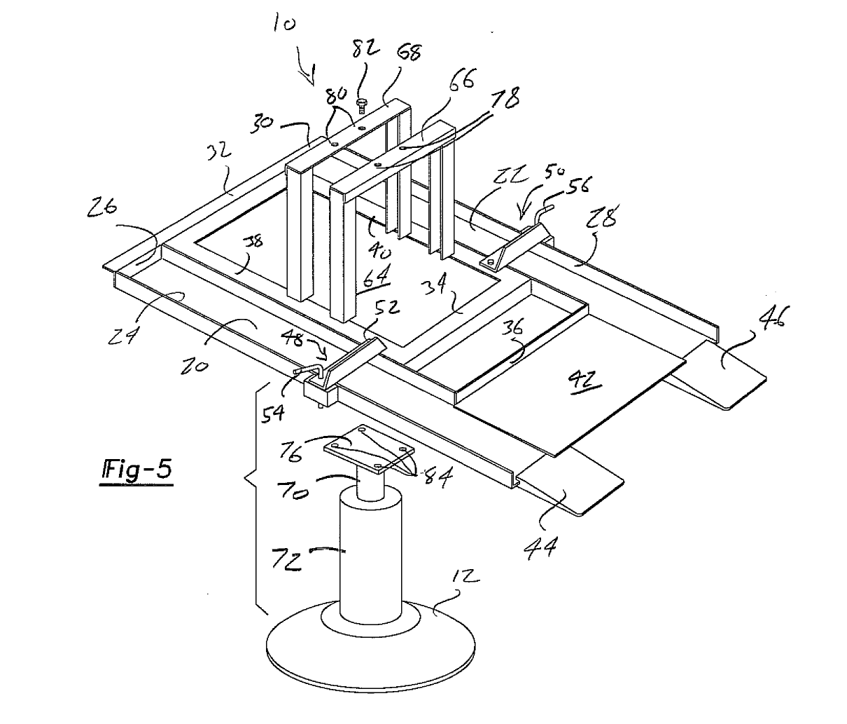

Referring now to FIGS. 1-8, the present invention discloses a novel frame structure 10 incorporated into a hair salon pedestal supported lift 12, and which provides such as a hair care professional with the ability to secure, elevate and selectively pivot a physically challenged individual seated upon a wheelchair 14, the wheelchair as known including a frame with seating area and both first 16 and second 18 pairs of wheels. The frame structure 10, as will be further described, can also be incorporated into such as a hydraulic lift component incorporated into the pedestal support 12, and in order to retrofit an existing salon chair assembly for use by disabled individuals limited to a wheelchair 14.

The frame structure 10 exhibits such as a steel or other durable construction and includes first and second wheelchair receiving and lengthwise extending channels 20 and 22, these each including side and end wall abutments (see further as shown respectively at 24 and 26 for channel 20 and at 28 and 30 for channel 22 in the exploded perspective of FIG. 5). The lengthwise extending channels 20 and 22 are supported in crosswise and structurally supporting fashion, such as by crosswise supports 32, 34 and 36 (see again FIG. 5). The supports 32 and 34 may be incorporated into an inner rectangular reinforcing frame (see additional side supports 38 and 40) and the forward most cross support 36 may define a crosswise abutment location with a forward support plate 42.

Additional features associated with the frame structure include forward ramps 44 and 46, these defining a roll-on (ingress) location when situated in a lowermost position relative to a ground location. The ramps 44 and 46 may in one embodiment be fixedly secured to forward associated locations of the wheelchair wheel receiving channels 20 and 22 and, in a further contemplated embodiment, may be pivotable so as to define a stored/non-use position.

A pair of crosswise extending locks are provided, see at 48 and 50, and are associated with intermediate locations of the channels 20 and 22, these defining a specified distance to such as the rear abutting ends 26 and 30 of the channels and in order to prevent relative movement of the wheelchair wheels when supported upon the frame. The crosswise extending locks, as further best illustrated by the enlarged sectional view of selected lock 48 in FIG. 7, further includes an angled bracket which is pivotally secured, such as by pin 52 to inner lengthwise support 38, and so that it is capable of being rotated from first positions substantially parallel to said wheelchair receiving channels, to second locations (as illustrated) whereby the brackets are disposed substantially perpendicular to their associated channels. A pin (see at 54 in FIG. 7 as well as at 54 and 56 in FIG. 5) inserts through a remote rotated end associated with each of the brackets, this further best shown by end support 58 in the enlarged view of FIG. 7 and which includes all aperture 60 which matingly aligns with aperture 62 defined in the associated bracket 48 in order to secure in place relative to contacting locations with the wheelchair wheels (e.g. larger wheels 16).

First and second supports are provided and which are secured to the frame in upwardly extending fashion, over an open central area (see generally as shown at 64 in FIG. 5) in order to secure the frame 10 to the vertically actuating lift 12. The supports are, in the selected variant illustrated, a pair of substantially “U” shaped front 66 and rear 68 drop bars, these each securing at inner edge locations of each of the channels 20 and 22 as shown.

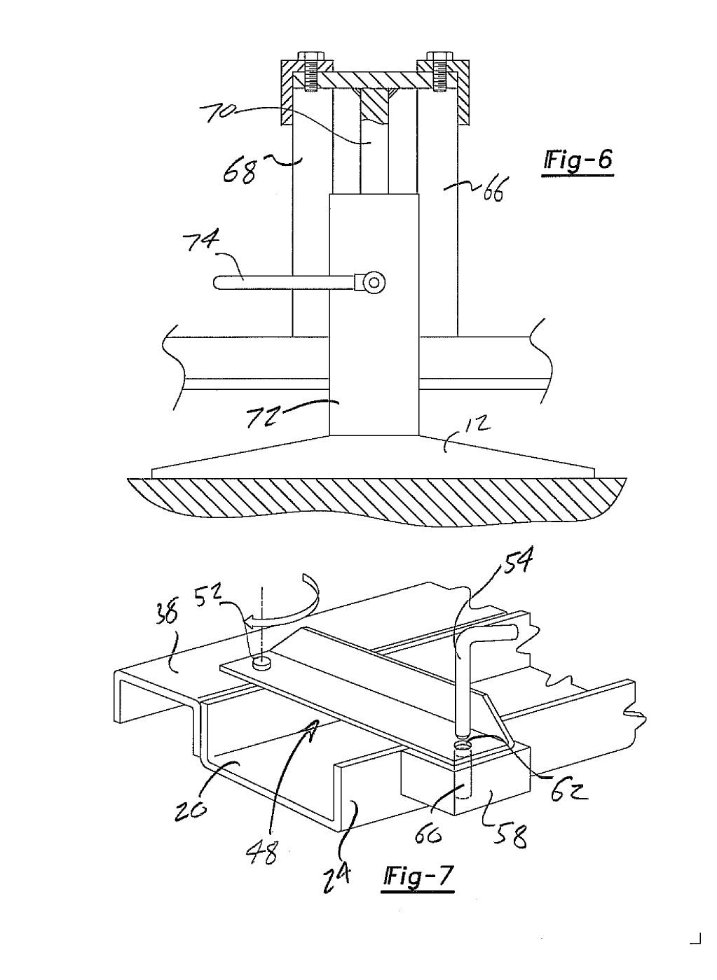

The vertical lift assembly 12 further includes an actuating cylinder 70, such as which extends vertically in telescoping fashion relative to a fixed outer housing 72 situated atop the pedestal base 12 and which defines the relevant structure of a hydraulic or other type of manual or powered lift assembly. The present inventions again contemplate any of a modified lift assembly particularly designed for use with the frame structure disclosed herein, as well as a retrofittable cylinder base utilized in a conventional salon chair assembly, and by which the chair component is removed and the pedestal base modified for supporting the frame structure 10 thereupon. As further best shown in FIG. 6, a step-actuating lift pedal 74 may be incorporated into the pedestal arrangement for vertically actuating (either upwardly or downwardly) the cylinder 70.

The vertically actuating cylinder 70 terminates in an upper end plate 76 (see as best shown in FIG. 5) and which is typically welded onto the top of the cylinder 70. Intermediate connecting portions associated with the front and rear drop bars 66 and 68 each further include apertures (see further at 78 and 80 in FIG. 5) through which are inserted fasteners (e.g. at 82) for securing the frame 10 via the drop bar supports 66 and 68, to the end plate 76, the end plate further illustrating apertures 84 therein for receiving the fasteners 82.

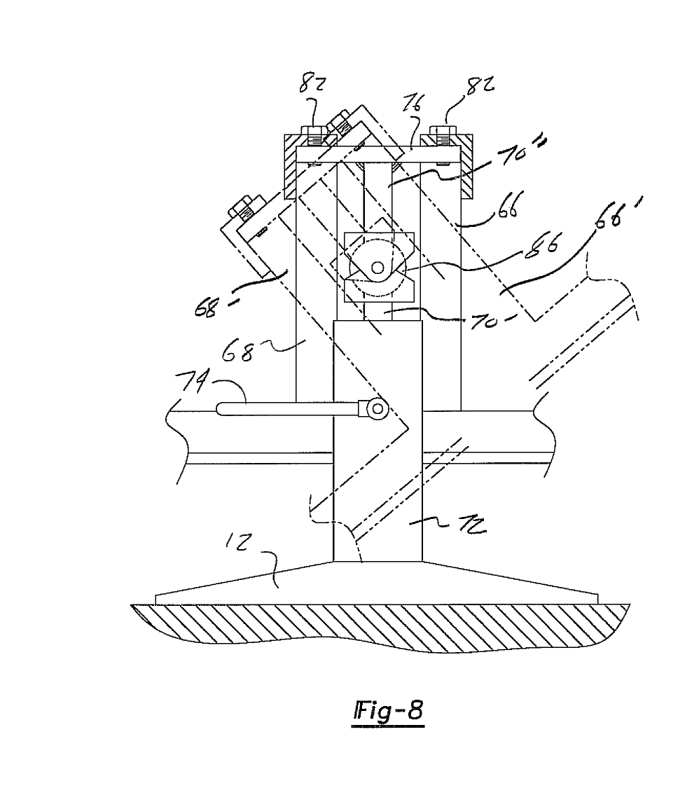

In this fashion, the frame 10 (and associated wheelchair 14) are supported in a balanced and safely elevatable fashion upon the vertically actuating pedestal base 12. An additional embodiment of the invention, as shown in FIG. 8, contemplates the incorporation of a rotary coupling (see at 86) and such as which can be incorporated into a modified arrangement of lift cylinder, this further including such as split portions 70′ and 70″, between which the coupling 86 is mounted. In this fashion, the frame (see phantom positions 66′ and 68′ associated with the support drop bars) is capable of being pivoted about a horizontal axis, in addition to being vertically actuating tip and down, this permitting such as a safe rearward tilting of the lift assembly to provide additional convenience to such as a hair care professional or other individual operating the assembly.

Having described my invention, other and additional preferred embodiments will become apparent to those skilled in the art to which it pertains, and without deviating from the scope of the appended claims.

I claim:

1. An assembly providing such as a hair care professional the ability to secure and elevate a physically challenged individual seated upon a wheelchair, comprising:
a frame including first and second spaced apart and crosswise-reinforced channels defining travel locations for receiving forward and rearward pairs of wheelchair wheels;
a pair of crosswise extending locks associated with intermediate locations of said channels and defining a spaced distance from end locations thereof to prevent relative movement of the wheelchair wheels when supported thereupon;
first and second supports securing to said frame and extending upwardly relative to an open area between said channels; and
a pedestal including a floor base from which vertically actuates a cylinder arranged to extend through said flame open area and between said supports, said supports mounting to said cylinder in order to secure said frame in balanced and vertically displaceable fashion upon said pedestal.

2. The assembly as described in claim 1, further comprising first and second ramps secured to associated ends of said channels and defining, in a lowered most location of said assembly, an ingress position for receiving the wheelchair.

3. The assembly as described in claim 1, said first and second supports further comprising a front drop bar and a spaced apart rear drop bar, each of said drop bars exhibiting a substantially “U” shape and securing at opposite ends to inner edge locations associated with said channels.

4. The assembly as described in claim 3, further comprising said vertically actuating cylinder terminating in an upper end plate, intermediate connecting portions associated with said drop bars each further including apertures through which are inserted fasteners for securing said frame, via said supports, to said end plate.

5. The assembly as described in claim 1, said crosswise extending locks further comprising a pair of angled brackets which are rotated from first positions substantially parallel to said wheelchair receiving chamiels, to second locations whereby said brackets are disposed substantially perpendicular to said channels, a pin inserting through a remote rotated end associated with each of said brackets to secure in place relative to contacting locations with the wheelchair wheels.

6. The assembly as described in claim 1, said floor supported pedestal exhibiting a specified shape and size and further comprising a lift pedal for vertically actuating said cylinder.

7. The assembly as described in claim 1, further comprising a rotary coupling incorporated into said cylinder for affording pivoting movement of said frame and associated wheelchair about a horizontal axis.

8. The assembly as described in claim 2, further comprising said ramps being pivotable relative to said channels between use and storage positions.

9. An assembly capable of being retrofit mounted upon a conventional and hydraulically actuating floor supported lift and providing such as a hair care professional the ability to secure and elevate a physically challenged individual seated upon a wheelchair, said assembly comprising:
a frame including first and second spaced apart and crosswise-reinforced channels defining travel locations for receiving forward and rearward pairs of wheelchair wheels;
first and second ramps securing to associated ends of said channels and defining, in a lowered most location of said assembly, an ingress position for receiving the wheelchair;
a pair of crosswise extending locks associated with intermediate locations of said channels and defining a spaced distance from end locations thereof to prevent relative movement of the wheelchair wheels when supported thereupon; and
first and second supports securing to said frame and extending upwardly relative to an open area between said channels;
the floor supported lift including a base from which vertically actuates a cylinder arranged to extend through said frame open area and between said supports, said supports mounting to the cylinder in order to secure said frame in balanced and vertically displaceable fashion upon the floor lift.

10. The assembly as described in claim 9, said first and second supports further comprising a front drop bar and a spaced apart rear drop bar, each of said drop bars exhibiting a substantially “U” shape and securing at opposite ends to inner edge locations associated with said channels.

11. The assembly as described in claim 10, further comprising an upper end plate adapted to being secured to a top edge of the vertically actuating cylinder, intermediate connecting portions associated with said drop bars each further including apertures through which are inserted fasteners for securing said frame, via said supports, to said end plate.

12. The assembly as described in claim 9, said crosswise extending locks further comprising a pair of angled brackets which are rotated from first positions substantially parallel to said wheelchair receiving channels, to second locations whereby said brackets are disposed substantially perpendicular to said channels, a pin inserting through a remote rotated end associated with each of said brackets to secure in place relative to contacting locations with the wheelchair wheels.

13. The assembly as described in claim 9, the floor supported lift exhibiting a specified shape and size and filer including a lift pedal adapted for vertically actuating the cylinder.

14. The assembly as described in claim 9, further comprising a rotary coupling adapted to being incorporated into the cylinder and for affording pivoting movement of said frame and associated wheelchair about a horizontal axis relative to the floor supported lift.

15. The assembly as described in claim 9, further comprising said ramps being pivotable relative to said channels between use and storage positions.
